(19) United States
(12) Patent Application Publication
(10) Pub. No.: US 2026/0057345 A1
(43) Pub. Date: Feb. 26, 2026

(54) METHOD AND SYSTEM FOR INTEGRATING DISJUNCT PROCESSES INTO A COHESIVELY SYSTEMATIC WORKFLOW

(71) Applicants: Ernest Barriga, Austin, TX (US); Ryan Barriga, Austin, TX (US)

(72) Inventors: Ernest Barriga, Austin, TX (US); Ryan Barriga, Austin, TX (US)

(21) Appl. No.: 18/815,049

(22) Filed: Aug. 26, 2024

(51) Int. Cl. G06Q 10/10; G06Q 10/0631

(52) U.S. Cl. CPC G06Q 10/103; G06Q 10/063118

(57) ABSTRACT

A method and apparatus for integrating multiple disjunct processes into a cohesive workflow can involve receiving proposal development inputs through a system linked to a back-end processor and user interface, and collecting with the proposal development, data for staffing and cost estimation, customizable per case. The data can be processed by a baseline development component to confirm realistic paths, establish target dates, and maintain cost and schedule metrics within tolerances. The system can update tasks, displays critical paths, and monitor performance metrics while integrating with a portfolio workforce planning component, staffing data across proposal, baseline development, and program execution components. This integration of staffing data can allow for strategic decision making and/or program prioritization.

### TECHNICAL FIELD

Embodiments relate to computer systems and more particularly to computer systems that utilize integrated software platforms for managing and automating core processes and operations. Embodiments further relate to computer systems that are adapted for managing and coordinating various aspects of projects. Embodiments also relate to computer systems adapted to facilitate the automation of repetitive tasks and streamline processes across different departments within an organization, ensuring efficiency and alignment of various processes like cost, schedule, workforce, and performance tracking. Embodiments also relate to methods and systems for integrating disjunct processes into a systematic workflow.

### BACKGROUND

In conventional computing systems and workflows, processes and components often operate in isolation from one another. These disjunct processes or components may not be integrated, leading to significant challenges that can hinder overall efficiency, accuracy, and productivity. There are a number of issues with disjunct processes in traditional computing and networked environments including but not limited to data silos, inefficiencies, misalignment of objectives, complexities in management, inaccurate forecast and planning, limited scalability, and poor performance tracking.

Disjunct processes maintain their own separate data repositories (e.g., data silos), resulting in fragmented information across the system. This fragmentation prevents seamless data flow, causing inconsistencies and redundancies. As a result, it becomes difficult to obtain a comprehensive view of the system's state, leading to poor decision-making and planning. Furthermore, the lack of integration may require manual intervention to transfer data and information between processes and components. This manual handling introduces delays and increases the risk of errors. It also consumes valuable time and resources that could be better utilized elsewhere.

Without a cohesive framework, different processes and components may operate based on conflicting or misaligned objectives. This misalignment can lead to inefficiencies, as efforts are duplicated or wasted, and goals are not achieved effectively. In addition, managing disjunct processes requires overseeing multiple isolated systems, each with its own set of tools, protocols, and interfaces. This complexity complicates system maintenance, troubleshooting, and updates, increasing the likelihood of system failures and downtime.

When processes and components do not share information, forecasting and planning become guesswork. Inaccurate data and lack of visibility into all parts of the system lead to poor planning, resulting in over or under-utilization of resources, budget overruns, and missed deadlines. Disjunct systems are inherently difficult to scale. As new components are added, the complexity of maintaining integrations and ensuring data consistency grows exponentially, making it challenging to expand the system effectively. Without integrated systems, performance tracking is unreliable. Each component may have its own performance metrics, which are not aligned with the overall system goals. This misalignment results in skewed performance assessments and hampers the ability to make informed improvements.

Given these substantial drawbacks, there is a clear need for a new approach to integrating disjunct processes and components within computing and networked environments. An integrated system would address these challenges by providing a unified framework that enables seamless data sharing, alignment of objectives, and streamlined management. Therefore, developing a new approach to integrate disjunct processes and components is crucial for overcoming the limitations of traditional systems, ultimately leading to more efficient, reliable, and scalable computing and networked environments.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an improved platform that can manage and automate core processes and operations for an organization (e.g., a company).

It is another aspect of the embodiments to provide for an improved method and system for coordinating various aspects of projects.

It is another aspect of the embodiments to provide for methods and systems for integrating disjunct processes into a cohesively systematic workflow.

The aforementioned aspects and other objectives and advantages can now be achieved as described herein.

In an embodiment, a method for integrating a plurality of disjunct processes into a cohesively systematic workflow, can involve: receiving, through a system operatively linked to a back end processor, via a front end user interface, an input to a proposal development component for development of a proposal, the input comprising a proposal development customizable with changes to parameters on a case-by-case basis indicative of a specific sequence of events, wherein the proposal development component collects data for determining staffing demands and estimating costs for use in generating the proposal; subjecting, by the system, data imported from the proposal development component to a baseline development component that iteratively processes the data in order to confirm realistic critical/driving paths, establish attainable target dates, and provide a highest probability of various cost and schedule performance metrics remaining within acceptable tolerances after setting a baseline and throughout a lifetime of a program related to the proposal; importing, by the system, data processed by the baseline development component, and updating with a program execution component, all tasks in a schedule comprising the program, displaying critical/driving paths, and monitoring a plurality of performance metrics; and integrating, through the system, staffing data from the data processed by the proposal development component, the baseline development component, and the program execution component.

In an embodiment, the system can comprise a split-database system.

An embodiment can further involve pinpointing a site-wide staffing demand in order to ensure that a supported company has adequate personnel, in response to integrating the staffing data, the baseline development component and the program execution component.

An embodiment of can also involve generating data usable by a team for insight into how the team operates and delegates resources more efficiently and cost-effectively, in response to integrating the staffing data, the baseline development component and the program execution component.

An embodiment can involve ensuring multiple commonly disjunct factors are in alignment with one another, in response to integrating the staffing data, the baseline development component and the program execution component.

In an embodiment, the multiple common factors can include, for example, one or more of: a cost, the schedule, a workforce, and performance tracking.

An embodiment can also involve dynamically adjusting the parameters of the proposal development component based on real-time feedback received from the baseline development component and the program execution component.

In an embodiment, the proposal development component can include a machine learning algorithm configured to predict staffing demands and cost estimates based on historical data and trends.

An embodiment can also involve generating visual analytics dashboards that display critical paths, performance metrics, and staffing data for easy interpretation by end users.

In an embodiment, the split-database system can employ a caching mechanism to improve data retrieval speed and reduce latency during high-demand periods.

In an embodiment, the program execution component can include a notification system that alerts relevant stakeholders of deviations from the established baseline or critical paths.

An embodiment may also involve recommending staffing adjustments based on predictive analytics derived from historical project data and current program execution metrics.

In an embodiment, an apparatus for integrating a plurality of disjunct processes into a cohesively systematic workflow, can include at least one processor and a memory, the memory storing instructions to cause the at least one processor to perform: receiving, through a system operatively linked to a back end processor, via a front end user interface, an input to a proposal development component for development of a proposal, the input comprising a proposal development customizable with changes to parameters on a case-by-case basis indicative of a specific sequence of events, wherein the proposal development component collects data for determining staffing demands and estimating costs for use in generating the proposal; subjecting, by the system, data imported from the proposal development component to a baseline development component that iteratively processes the data in order to confirm realistic critical/driving paths, establish attainable target dates, and provide a highest probability of various cost and schedule performance metrics remaining within acceptable tolerances after setting a baseline and throughout a lifetime of a program related to the proposal; importing, by the system, data processed by the baseline development component, and updating with a program execution component, all tasks in a schedule comprising the program, displaying critical/driving paths, and monitoring a plurality of performance metrics; and integrating, through the system, staffing data from the data processed by the proposal development component, the baseline development component, and the program execution component.

Embodiments relate to methods, apparatuses, and systems for integrating multiple disjunct processes into a cohesive workflow can involve receiving proposal development inputs through a system linked to a back-end processor and user interface, and collecting with the proposal development, data for staffing and cost estimation, customizable per case. The data can be processed by a baseline development component to confirm realistic paths, establish target dates, and maintain cost and schedule metrics within tolerances. The system can update tasks, displays critical paths, and monitor performance metrics while integrating staffing data across proposal, baseline development, and program execution components.

The overarching integration of these elements drives the workforce planning component that can streamline a company's processes and drastically improve efficiency. The workforce planning component disclosed herein allows for program prioritization and strategic portfolio decision-making. This comprehensive approach to integrating disparate processes not only enhances operational alignment but also ensures that project delivery is both timely and cost-effective. Ultimately, the embodiments can empower organizations to make informed, strategic, economical decisions while optimizing resource allocation and enhancing performance metrics.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a block diagram depicting a system for integrating disjunct processes into a cohesively systematic workflow, in accordance with an embodiment;

FIG. 2 illustrates a flow diagram depicting a workflow of components for integrating disjunct processes into a cohesively systematic workflow, in accordance with an embodiment;

FIG. 3 illustrates a flow-chart of operations depicting logical operational steps of a method for integrating disjunct processes into a cohesively systematic workflow, in accordance with an embodiment;

FIG. 4 illustrates a flow-chart of operations depicting additional logical operational steps of the method depicted in FIG. 3, which may be implemented in accordance with an embodiment;

FIG. 5 illustrates a block diagram depicting a split-database system, which may be implemented in accordance with an embodiment;

FIG. 6 illustrates a schematic diagram of an example operating environment in accordance with one or more implementations described herein;

FIG. 7 illustrates a screenshot of an example baseline development interface, which may be implemented through a baseline development component, in accordance with an embodiment;

FIG. 8 illustrates a screenshot of an example program execution interface, which may be implemented as part of a program execution component, in accordance with an embodiment;

FIG. 9 illustrates a screenshot of an example portfolio workforce planning interface, which may be implemented as part of a portfolio workforce planning component, in accordance with an embodiment; and

FIG. 10 illustrates a screenshot of an example proposal development interface, which may be implemented as part of an example proposal development component, in accordance with an embodiment.

In the drawings described and illustrated herein, identical or similar parts and elements are generally indicated by identical reference numerals.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may or may not necessarily refer to the same embodiment. Similarly, phrase such as “in another embodiment” or “in another example embodiment” and variations thereof as utilized herein may or may not necessarily refer to a different embodiment. It is intended, for example, that the claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense.

Furthermore, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

As utilized herein, the term ‘system’ can relate to a combination of hardware, software, and/or network components that work together to perform a specific function or set of functions. A ‘system’ may include various interconnected modules, devices, processors, and interfaces that collectively achieve the desired outcome, as described in the patent claims. The system's architecture, components, and the interactions between them can operate to solve a particular problem or perform a particular task. The term ‘apparatus’ as utilized herein may be used interchangeably with the term ‘system’. The term ‘apparatus’ can also relate to a physical device or a combination of mechanical, electrical, or electronic components designed to perform a specific function or set of functions. A system may include an apparatus. Likewise, an apparatus may include a system or system(s).

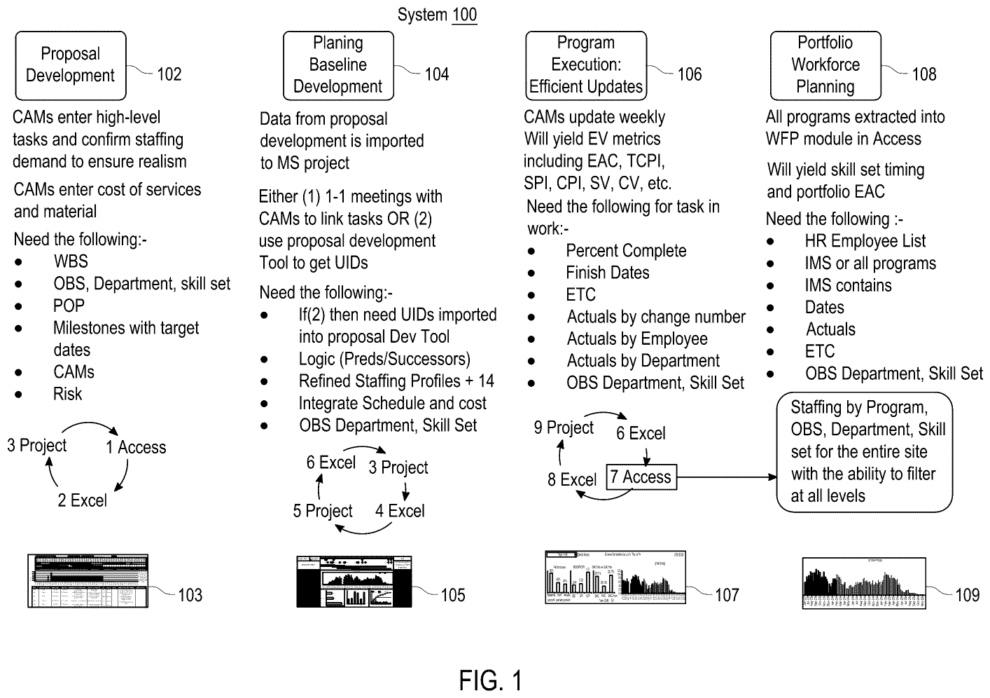

FIG. 1 illustrates a block diagram depicting a system 100 for integrating disjunct processes into a cohesively systematic workflow, in accordance with an embodiment. Note that the term ‘disjunct’ as utilized herein can relate to a disjunct process or component, which may be a process or component that operates independently and separately from others within a system or workflow. These disjunct elements lack integration, coordination, and communication with each other, often resulting in inefficiencies, data silos, and a lack of cohesive functionality. In practical terms, this means each disjunct process or component handles its tasks in isolation, without considering or leveraging the inputs, outputs, or operational context of other processes or components in the system. This separation can lead to redundancies, errors, and misalignment of objectives within an organization.

The system show in FIG. 1 includes a group of components, which may be normally disjunct from one another, but which are integrated in a cohesive workflow through system 100. The system can include a proposal development component 102, a baseline development component 104, a program execution component 106, and a portfolio workforce planning component 108. The system 100 can be implemented as a combination of a process, a system and a product that can integrate at least several processes (e.g., proposal development, baseline development, program execution and workforce planning), which may be typically treated separately by industry. The system 100 can ensure, however, that multiple common factors (e.g., cost, schedule, workforce, performance tracking, etc.) are, for example, 100% in alignment with one another. Example graphical user interfaces 103, 105, 107, and 109 shown in FIG. 1 are respectively associated with the proposal development component 102, the baseline development 106, the program execution component 106 and the workforce planning component 108.

The proposal development component 102, the baseline development component 104, the program execution component 106, and the workforce planning component 108 can be integrated into a single tool, which can ensure cost schedule, performance tracking and overarching staffing requirements are 100% in alignment. With conventional technology, proposal development, baseline development, program execution, and workforce planning may be treated separately and therefore the data is disconnected.

The system 100, however, differs from current approaches because it combines and integrates all the processes, thereby providing visibility and coordination across all components and platforms. Because industry typically treats each of these areas separately, with each process or component not offering insight into the others, there are severe gaps in program execution, program performance, forecasting, and workforce planning.

Different personnel can be involved in these processes, which in turn can lead to poor hand-offs from proposal development to baseline development and from baseline development to program execution. Furthermore, there does not currently exist a standard way to capture data, which creates more work for those who need to process inputs which is time-consuming and inefficient. The disclosed embodiments offer a better approach across all processes for several reasons including standardized input, the ability to develop realistic and attainable plans, efficiency of weekly schedule updates, and the visibility of the workforce required for optimal operations.

During proposal development, with conventional technology, staffing requirements are not visible leading to proposal costs coming in too high leading to non-competitive or losing bids. Business has been lost due to the proposal cost coming in too high because bidders could not see the staffing requirement resulting from their hours input. The inventors have, for example, encountered proposal hours come in 100% to 1000% over actual staffing requirements due to this blind spot. The estimates are non-standardized and inaccurate, making the cost estimator's job more difficult than it needs to be. The inefficient nature of non-standardized input forces the cost estimator to manually enter data, creating room for error, and slows down the process to get a dollar figure. The team must wait for the cost estimator to input all the data before they can make any updates or modifications.

The disclosed embodiments ensure, for example, that the team does not overbid by providing staffing requirements and the timing of these requirements in real-time as they estimate their tasks. The possibility of overbidding is completely avoided by using, for example, a software suite or platform, and bidders can develop fully accurate hours and staffing requirements and therefore more realistic and accurate proposals. In addition, the standardized approach guarantees speed, efficiency, and accuracy. Dollar figures can be calculated instantaneously, either directly in the invention or by importing the data directly into cost estimating software. This approach can prevent the cost estimator from having to manually enter data, thereby eliminating room for error, while providing instant dollar amounts to the team so they can immediately adjust if necessary. The Proposal Development section or proposal development component 102 makes this process more accurate, more efficient, and more streamlined, leading to winning proposals and seamless baseline development.

In addition, with conventional technology during Baseline Development, there is not a smooth transition from the Proposal phase since this can be different personnel using different tools. There is a tendency to use inaccurate proposal data or start the estimating process over again which is inefficient and confusing, which is the current industry standard. In addition, there is usually a 10% reduction in hours across the board for risk mitigation, so team-members only use a portion of the hours that were estimated during a Proposal Development phase, which may be inaccurate to begin with. This can further affect accuracy since different team-members have different risk profiles and should therefore have different values set aside for risk.

Since staffing requirements are not visible, unrealistic, and unattainable plans may be developed. Impossible program plans, for example, are set in stone because there is no insight into staffing demands, resulting in being off performance targets within one to two months into the program execution phase. This can create unnecessary extra work because the team must investigate and report why they were off target. This takes time and effort away from actual work, which is another added inefficiency. Like the proposal development phase, the inefficient nature of non-standardized input can force the planner to constantly adjust to different input formatting, creating room for error, and slowing down the planning process. Another unfortunate effect of non-standardization is the team must manually keep up with the latest information. This makes the team prone to not working with the latest information resulting in replanning and rework. All of this is counterproductive, uneconomical, and contributes to unrealistic plans.

Creating and developing realistic plans is the foundation for a team's success and this is one of the important results which can be achieved from implementing the disclosed embodiments. That is, the embodiments can provide for a seamless transition from the proposal development process to the baseline development process since standardized, accurate data can be leveraged as a starting point. This approach also can provide situational awareness to ensure the development of realistic and attainable plans by ensuring available workforce is driving the process. This may seem like ‘common sense’ which every company or organization should follow; however, this is not the industry standard, and nothing could be further from the truth.

Since Baseline Development is accomplished by a different department than workforce requirements, there is always a huge disconnect here. An important features of the disclosed embodiments involves supporting the development of realistic and attainable baselines by making the required staffing part of the process. This visibility allows all departments to see staffing requirements and plan accordingly. This can also help in the development of accurate risk profiles for each individual team-member instead of, for example, a canned 10% reduction for all team-members. Developing a realistic and attainable baseline is absolutely crucial due to its enormous impact on the next and most expensive phase, program execution.

With conventional technology during program execution, the updating and forecasting process is extremely inefficient and prone to error. Individual spreadsheets may be used to gather input from team members. These are usually non-standardized and the person processing these spreadsheets will have to deal with a plethora of spreadsheets per program making the updating process even more cumbersome. Errors and incomplete updates are guaranteed. Not only does the person processing these updates have to deal with a multitude of spreadsheets, the team members filling them out also must deal with multiple spreadsheets since they are often working on multiple programs. The estimating process for hours is usually omitted during weekly updates and only addressed quarterly. Since hours estimates drive programmatic forecasts and required workforce, this causes a severe disconnect and as a result, programs are always behind in hiring required staffing and leads to inaccurate program cost estimates. Quarterly estimates for programs, for example, are time-consuming and detract from actual program work.

Since the same estimating process is followed during the program execution phase or process as baseline development, these forecasts are also inaccurate. It is a constant spiral of taking time and effort to produce inaccurate information while detracting from actual work. Since the team is working to poor plans and inaccurate forecasts the performance tracking is unreliable and unusable. Poor performance tracking leads to bad forecasts which also causes extra work as team members investigate why they are not meeting cost and schedule. The team cannot see that the simple reason is that the forecasts are unrealistic. If programs get so far off track that the performance measurement and forecasts are unreliable, then they will be forced to replan which can be, for example, 15-20% of total program cost for only one round of replanning. However, the embodiments can solve all these issues allowing the team to focus on their work and maximize their effort during the program execution phase/process.

The embodiments' features make the updating process easy, efficient, and accurate throughout the program execution phase. The embodiments also produce extremely accurate forecasts. Multiple programs can be updated from one input source instead of multiple spreadsheets. This is a game-changer. The efficient updating process can be done in a fraction of the time as traditional updates, conservatively saving, for example, more than 50% of schedule updating costs while yielding accurate and error-free updates. The speed and accuracy of these updates result in the team having the latest programmatic performance analytics in real-time allowing them to make immediate course corrections, facilitating teamwork and coordination vs. the four-to-six-week delay in traditional performance tracking systems. Since the team is working with realistic and attainable plans developed with the disclosed Baseline Development component, the performance measurement is extremely useful with no threat or concern of having to replan, which can save, for example, 15-20% of total program costs which could be hundreds of thousands to millions of dollars.

With conventional technology, staffing requirements are manually entered into their own system, independent of program data. This is another disconnect because program data is unusable, forcing the person entering staffing requirements to go by gut feel instead of hard data. This manual entry is disconnected from the program schedule. Since typical program schedules are unrealistic and therefore have unrealistic staffing requirements, this renders the schedule staffing data useless. So, this is a double-whammy, a useless staffing profile from the schedule and manually entered staffing requirements that are disconnected from the schedule. Another issue is that these stand-alone staffing systems are unique to functional groups like Engineering or Operations.

Thus, an organization's human resources department needs to view multiple systems with different formats to understand staffing requirements. Not only do these staffing disconnects exist within each program, but this also occurs from program to program. Programs are not aware that they may be vying for the same resources or the impact of not getting those resources and if they are, then the resources usually go to the program that screams the loudest instead of analytical portfolio priorities. This is an extremely inefficient and unproductive way to manage resources. When it comes to people, processes, and tools within companies, people may be the most important part of the embodiments, because the embodiments allows optimal management of this most valuable resource through the Workforce Planning umbrella.

The portfolio workforce planning component 108 can serve as an umbrella over all previous phases/components due to its unique integration. The workforce planning component 108 can be automatically populated by all the previous phases instead of manual entry into independent, stand-alone tools such as is the case with conventional technologies. The workforce planning umbrella or component 108 can be integrated with the proposal development component 102, the baseline development component 104, and the program execution component 106 and can use data from these components to provide the most accurate staffing requirements. A visual representation can be provided throughout all company/organizational levels from the entire site or individual portfolios, all the way down to individual employee and skill set make the workforce identification process very efficient. The portfolio workforce planning component 108 can leverage the staffing requirements from realistic planning and accurate forecasting into one system. By having all current and potential future work readily available and accessible, the deployment and hiring of personnel by functional managers is much easier to manage and coordinate with human resources and portfolio priorities can be managed more effectively.

System 100 can therefore be implemented to integrate disjointed processes into a cohesive workflow, in accordance with an embodiment. This system consolidates several normally independent components into a unified workflow, enhancing their efficiency and alignment. The components include the proposal development component 102, the baseline development component 104, the program execution component 106, and the portfolio workforce planning component 108. System 100 integrates various processes, typically handled separately in the industry, into a seamless workflow. This integration ensures that multiple common factors, such as cost, schedule, workforce, and performance tracking, are fully aligned.

The proposal development component 102 can handle the initial phase of creating proposals. In conventional setups, proposal development is isolated, leading to disconnected data and inefficiencies. The baseline development component 104 can follow the proposal development phase, establishing the baseline for the project. Traditionally, different personnel and tools lead to inaccuracies and inefficiencies in transitioning from proposals to baseline development. During program execution, updating and forecasting processes are prone to errors due to the use of non-standardized spreadsheets. System 100, on the other hand, through the use of the program execution component 106, can provide accurate forecasts and efficient updates, significantly reducing errors and inefficiencies. The portfolio workforce planning component 108 can serve as an umbrella over all previous phases, this component automatically populates staffing requirements, ensuring efficient workforce planning. This component can provide a visual representation of, for example, staffing needs across organizational levels, aiding in effective management and coordination.

System 100 offers several advantages over traditional approaches. For example, by integrating all components into a single tool, system 100 can ensure seamless integrating including alignment of, for example, cost, schedule, performance tracking, and staffing requirements. System 100 also can standardize inputs, reducing errors and inefficiencies associated with non-standardized data entry. System 100 also provides for real-time visibility into staffing requirements, which may prevent overbidding and ensure accurate proposals, thereby improving competitiveness. With system 100, updates can be performed more efficiently, saving significant time and costs, while providing accurate and real-time program analytics. The system 100 also supports the development of realistic and attainable plans, thereby enhancing program performance and reducing the need for costly replanning. By providing accurate staffing data and integrating it with program schedules, the system 100 enables optimal workforce management.

The disclosed embodiments of system 100 address significant inefficiencies and inaccuracies in traditional processes by providing a standardized, integrated approach. This system enhances the accuracy, efficiency, and effectiveness of proposal development, baseline development, program execution, and workforce planning, leading to improved program performance and resource management.

The system 100 offers numerous advantages by integrating disjunct processes and components into a cohesive, systematic workflow. System 100 can provide for a unified framework, which can consolidate various independent processes such as proposal development, baseline development, program execution, and workforce planning into a single, integrated tool. This unification ensures that all processes operate in harmony, reducing the risk of miscommunication and misalignment. System 100 also can eliminate data silos. By integrating data across all components, the system eliminates fragmented data silos, ensuring that information flows seamlessly and is readily accessible by all relevant processes.

System 100 also provides enhanced efficiency with improved automated data transfer and streamlined workflow. For example, system 100 can automate the transfer of data between different components, minimizing the need for manual data entry and reducing the associated errors and delays. Integrated processes lead to more streamlined workflows, saving time and resources that would otherwise be spent on coordinating disjointed activities.

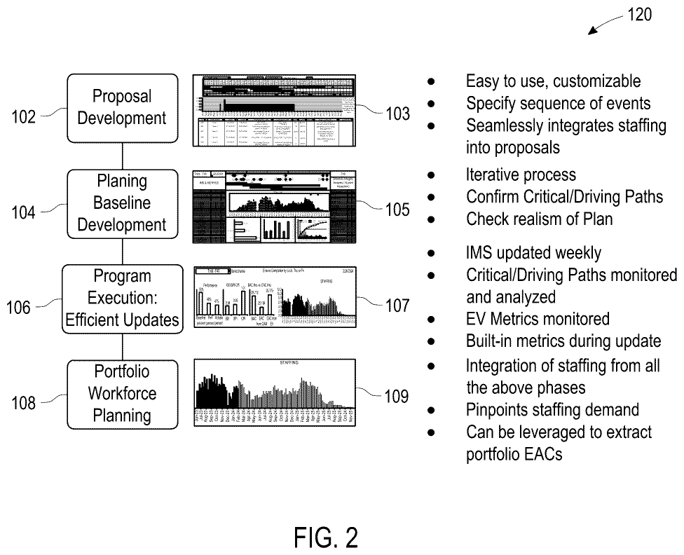

FIG. 2 illustrates a flow diagram depicting the components for integrating disjunct processes into a cohesively systematic workflow 120, in accordance with an embodiment. Note that as utilized herein, identical or similar parts or features are generally indicated by identical reference numerals. Thus, the workflow 120 shown in FIG. 1 includes the flow of data from one component to another, beginning with the proposal development component 102 followed by the baseline development component 104, and then the program execution component 106, and finally, the portfolio workforce planning component 108.

The proposal development component 102 can be implemented as an easy-to-use customizable module with respect to a specific sequence of events. The proposal development component 102 can seamlessly integrate, for example, staffing data into proposals. The baseline development component 104 can be implemented as an iterative process, which can confirm critical/driving paths and check the realism of a plan/proposal. With the program execution component 106, IMS can be updated weekly and critical/driving paths monitored and analyzed. EV metrics may also be monitored with the program execution component 106 and built-in metrics implemented during updates. The portfolio workforce planning component 108 can integrate staffing data, for example, from all of the aforementioned phases/components 102, 104, and 106. The portfolio workforce planning component 108 can also pinpoint staffing demand. Furthermore, the portfolio workforce planning component 108 may be leveraged to extract portfolio EACs.

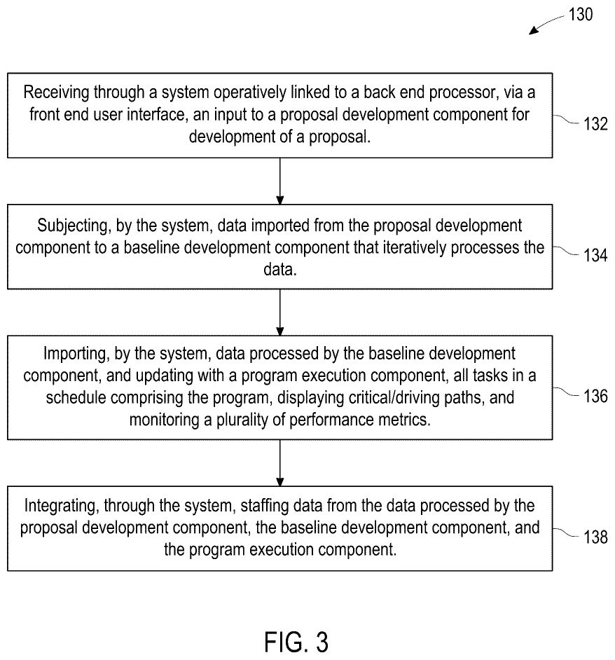

FIG. 3 illustrates a flow-chart of operations depicting logical operational steps of a method 130 for integrating disjunct processes into a cohesively systematic workflow, in accordance with an embodiment. As shown at block 132, a step or operation can be implemented for receiving, through a system operatively linked to a back end processor, via a front end user interface, an input to a proposal development component for development of a proposal. The aforementioned input can comprise a development customizable with changes to parameters on a case-by-case basis indicative of a specific sequence of events. In addition, the proposal development component can collect data for determining staffing demands and estimating costs for use in generating the proposal.

As shown next at block 134, a step or operation can be implemented for subjecting, by the system, data imported from the proposal development component to a baseline development component that iteratively processes the data in order to confirm realistic critical/driving paths, establish attainable target dates, and provide a highest probability of various cost and schedule performance metrics remaining within acceptable tolerances after setting a baseline and throughout a lifetime of a program related to the proposal.

Next, as shown at block 136, a step or operation can be implemented for importing, by the system, data processed by the baseline development component, and updating with a program execution component, all tasks in a schedule comprising the program, displaying critical/driving paths, and monitoring a plurality of performance metrics. Then, as depicted at block 138, a step or operation can be implemented for integrating, through the system, staffing data from the data processed by the proposal development component, the baseline development component, and the program execution component.

Note that in some embodiments, the aforementioned system can be implemented as a split-database system. Note that the term “split-database system” as utilized herein, can relate to a database architecture where the database can be divided into multiple, smaller, and more manageable segments or partitions, which can be distributed across different servers or locations. This approach can be designed to enhance performance, scalability, and reliability by distributing the workload and storage requirements.

Characteristics of the split-database system can include data portioning such as horizontal partitioning and vertical partitioning. In horizontal partitioning, the database tables can be split into rows, with each segment containing a subset of the rows. Each partition might hold a specific range of data, such as customer records for a specific region. In vertical partitioning the database tables can be split into columns, with each segment containing a subset of the columns. This can be useful when certain columns are frequently accessed together.

The split-database system can also make use of distributed storage, wherein the partitions or segments of the database are stored across multiple servers or locations, which can be geographically dispersed. This distribution helps in balancing the load and improving access times. By spreading the data across multiple servers, the system can distribute the query and transaction load more evenly. This load balancing helps in preventing any single server from becoming a bottleneck.

The split-database system can easily scale out by adding more servers or storage resources. As the data grows, new partitions can be created and distributed without disrupting the existing setup. Distributing the data across multiple locations can improve fault tolerance. If one server fails, the split-database system can still function using the data from other servers. Redundancy can be implemented to ensure data availability and integrity.

By partitioning the data, queries can be directed to specific partitions, reducing the amount of data that needs to be scanned and improving query performance. Each server can be optimized for the specific subset of data it handles. Additionally, in the split-database system, different partitions can be maintained and updated independently, allowing for more flexible and less disruptive maintenance schedules.

The split-database system can be implemented as an advanced database architecture that divides the database into smaller, more manageable segments, distributed across multiple servers or locations. This design enhances performance, scalability, fault tolerance, and maintenance flexibility, making it suitable for various large-scale and high-availability applications.

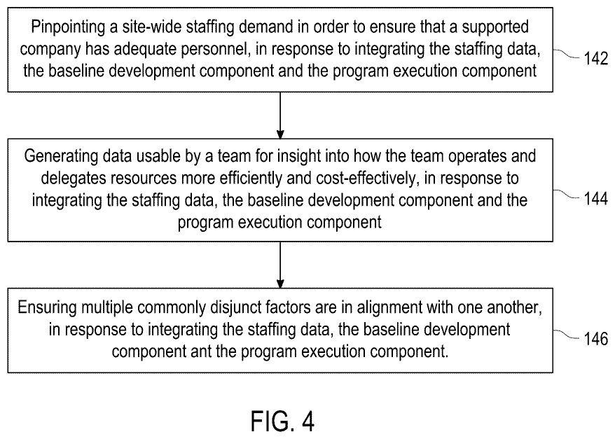

FIG. 4 illustrates a flow-chart of operations depicting additional logical operational steps of the method depicted in FIG. 3, which may be implemented in accordance with an embodiment. As shown at block 142, a step or operation can be implemented for pinpointing a site-wide staffing demand in order to ensure that a supported company has adequate personnel, in response to integrating the staffing data, the baseline development component and the program execution component.

As indicated at block 144, a step or operation can be implemented for generating data usable by a team for insight into how the team operates and delegates resources more efficiently and cost-effectively, in response to integrating the staffing data, the baseline development component and the program execution component. As shown at block 146, a step or operation can be implemented for ensuring multiple commonly disjunct factors are in alignment with one another, in response to integrating the staffing data, the baseline development component and the program execution component. Note that the aforementioned multiple common factors can include one or more of: a cost, the schedule, a workforce, and performance tracking.

The method 130 described herein with respect to FIG. 3 and FIG. 4 can integrate disjoint processes into a cohesive workflow using a series of logical operational steps. This involves several key components. The proposal development component process shown at block 132 can receive inputs for developing proposals. The operation depicted at block 132 provides for customizable parameters for different sequences of events and collects data for determining staffing needs and estimate costs. The baseline development process shown at block 134 involves processing data from the proposal development component and confirming critical paths, establishes target dates, and ensures performance metrics remain within acceptable limits. The program execution operation depicted at block 136 can involve updating schedules and tasks using the processed data. The program execution operation shown at block 136 can also involve graphically displaying through a graphical user interface critical paths and monitoring performance metrics. The operation shown at block 138 involves integrating staffing data from all components to ensure alignment.

The method 130 can provide a systematic approach to integrating various processes into a unified workflow, ensuring efficient proposal development, baseline establishment, and program execution. By employing a split-database system, for example, the architecture implemented with the disclosed embodiments can enhance the system's scalability, performance, and fault tolerance, making it suitable for large-scale, high-availability applications. The integration of staffing data can further align cost, schedule, workforce, and performance tracking, optimizing overall resource management and operational efficiency.

The disclosed embodiments provide for a number of advantages over conventional approaches including improved accuracy, better planning and forecasting, reduced costs, improved performance tracking, enhanced collaboration, scalability and flexibility, compliance and standardization, and strategic resource management.

The embodiments can standardize data inputs across all processes, reducing the variability and inaccuracies that arise from non-standardized data entry. System 100 also provides real-time visibility into staffing requirements, cost estimates, and performance metrics, ensuring that all decisions are based on the most current and accurate data. Furthermore, the disclosed integrated system and method can provide a holistic view of all processes, enabling more accurate forecasting and resource planning. This visibility helps in developing realistic and attainable plans that align with actual staffing and budget constraints. In addition, the system and method can ensure that all stakeholders have access to up-to-date information, facilitating better situational awareness and informed decision-making.

By providing accurate staffing requirements and aligning them with project schedules, the embodiments facilitate optimizing resource utilization, thereby reducing costs associated with overstaffing or understaffing. The embodiments' accurate planning and real-time updates reduce the need for costly replanning and course corrections, saving significant program costs.

Integrated performance metrics can provide reliable and actionable insights into program performance, enabling continuous improvement and timely interventions. Real-time analytics allow teams to make immediate course corrections, enhancing overall program performance and reducing the time lag associated with traditional performance tracking systems. The embodiments can also foster better communication and coordination among different teams by providing a common platform for all processes. This unified approach enhances teamwork and collaboration. By integrating workforce planning with other components, the system ensures that all departments have visibility into staffing requirements and can plan accordingly.

The integrated framework offered by the embodiments can simplify the process of scaling up operations, as new components can be added with minimal disruption and consistent data integration. The embodiments are adaptable to various organizational needs, providing a flexible solution that can be tailored to specific requirements. The system's standardized processes and accurate data management help in ensuring compliance with industry regulations and standards. By standardizing workflows and data inputs, the embodiments promote consistent practices across the organization, enhancing overall reliability and quality. The portfolio workforce planning component provides a comprehensive view of staffing needs, enabling strategic deployment and hiring of personnel. This ensures that resources are allocated effectively, aligning with both current and future organizational priorities.

The embodiments also can provide a robust solution to the challenges posed by disjunct processes and components. By integrating various independent processes into a cohesive and systematic workflow, the system enhances efficiency, accuracy, planning, performance tracking, collaboration, and scalability, ultimately leading to more effective and optimized operations.

The embodiments can solve the massive disconnect that exists between Proposal Development, Baseline Development, Program Execution, Performance Tracking, and Workforce Planning. This is a very expensive problem that plagues the industry. Due to industry operating standards, this is not readily apparent. Business continues in a suboptimal manner because programs are not even aware there is an issue. Even if they are, they cannot solve it due to lack of experience, knowledge, and expertise.

Their negative effects, however, on resource management, financial forecasting, and program performance are staggering. Companies do not realize their efficiency can skyrocket by combining and integrating Proposal Development, Baseline Development, Program Execution, and Workforce Planning. Portfolio forecasts can be much more accurate, priorities will be better managed, and staffing demand can be pinpointed to better prepare for future requirements. However, since companies do not do this, several problems arise including, (1) Lost business due to proposal bids coming in too high; (2) Programs develop and commit to unrealistic plans and therefore spend unnecessary time and money reporting as to why they are not on schedule or meeting costs; (3) Programs spend far more time than necessary updating schedules and estimating costs that are inaccurate and incomplete which leads to more wasted time, and; (4) Workforce planning is not aligned with program schedule data due to schedule inaccuracies and stand-alone workforce planning tools.

The embodiment can solve all these issues by integrating Proposal Development, Baseline Development, Program Execution, Performance Tracking, and Workforce Planning. The embodiments can bridge the experience, knowledge, expertise gap with easy-to-use tools and methodical steps. The embodiments can ensure: (1) winning proposals by providing an accurate staffing requirement because the team members can see their input represented graphically; (2) realistic and attainable plans, allowing the team to focus on their work during program execution; (3) accurate and efficient updates for all programs into only one source, eliminating errors, redundancies, and the need for multiple spreadsheets; and (4) leveraging accurate staffing input from Proposal Development, Baseline Development, and Program Execution into one source. This is a tremendous advantage because all workforce data is accurate and aligned with proposals and program schedule data. This makes company-wide workforce planning, program forecasting, and portfolio prioritization manageable and controllable. The accuracy, efficiency, and time-savings of the embodiments can enhance credibility with customers across industry and inspires confidence with future work, while obtaining the most out of the workforce, and empowering companies/organizations.

Note that each the illustrated components or blocks such as the proposal development component 102, the baseline planning development component 104, the program execution component 106, and the portfolio workforce planning component 108 may be implemented as modules. Although not required, the disclosed embodiments can be described in the general context of computer-executable instructions, such as program modules, being executed by a single computer or a group of computers. In most instances, such a “module” or component may constitute a software application but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which may be typically private (accessible only to that module) and which includes source code that actually implements the routines in the module. The term module may also simply refer to an application, such as a computer program designed to assist in the performance of a specific task, such as word processing, accounting, inventory management, etc.

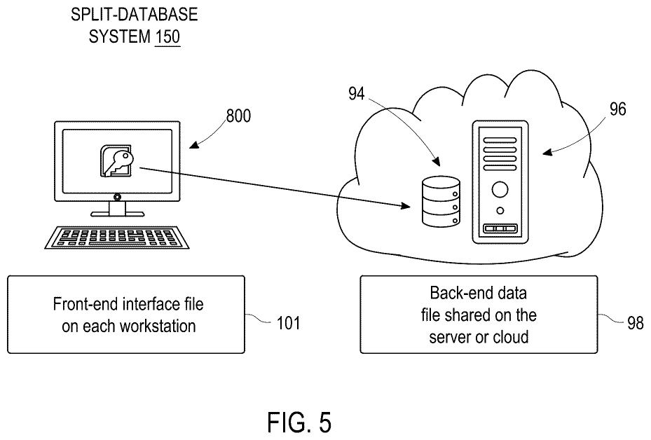

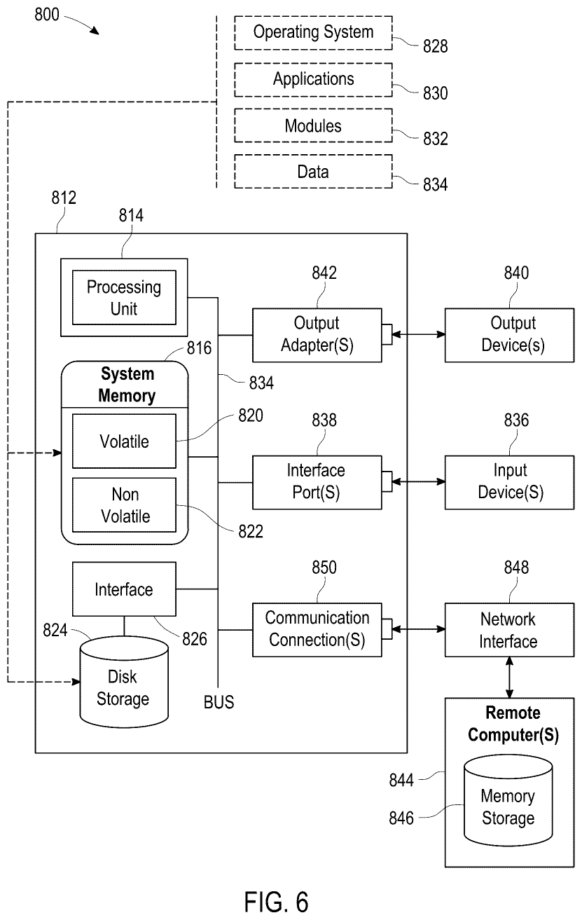

In some example embodiments, the term “module” can also refer to a modular hardware component or a component that is a combination of hardware and software. It should be appreciated that implementation and processing of such modules or components according to the approach described herein can lead to improvements in processing speed and in energy savings and efficiencies in a data-processing system such as, for example, the system 100 described previously and/or the operating environment 800 discussed below with respect to FIG. 6. The various components 102, 104, 106, and 108 when integrated as disclosed herein may lead to improvements data retrieval speed and a reduction in latency. The system 100 may comprise, for example, a split-database system as discussed previously and depicted in FIG. 5, which may employ in some embodiments, a caching mechanism to improve data retrieval speed and reduce latency during high-demand periods.

FIG. 5 illustrates a block diagram depicting a split-database system 150, which may be implemented in accordance with an embodiment. As noted above, the system 100 can include and/or operate in the context of a split-database system such as, for example, the split-database system 150. In the example shown in FIG. 5, the split-database system 150 can include an operating environment 800, which may be, for example, a workstation. Note that more details about the operating environment 800 are shown in the example depicted and described below with respect to FIG. 6. The operating environment 800 may be implemented or may include a front end user interface 101. That is, a front-end interface file may be installed or implemented via each workstation.

The split-database system 150 also can include a database 94 (or a group of interacting databases) in communication with a server 96 (or a group of servers). The server 96 may function as a back-end processor and a back-end data file may be stored in the database 94 and shared on the server 96 or via the ‘cloud’. An example a database, which may be used to implement database 94 is the database or memory storage device 846 shown in FIG. 6. An example of server 96 is the remote computer(s) 844 feature also shown in FIG. 6.

The system 100 can be advantageously implemented as or to include the split-database system 150 shown in FIG. 5 to significantly enhance data retrieval speed and reduce latency during high-demand periods. This configuration is particularly beneficial for integrating processes such as proposal development, baseline development, program execution, and workforce planning, which are typically treated separately in the industry. The graphical user interfaces 103, 105, 107, and 109, previously illustrated in FIG. 1, correspond to these components within system 100, ensuring that common factors such as cost, schedule, workforce, and performance tracking are fully aligned.

The split-database system 150 can divide a database into a front-end file and a back-end file. The back-end file, also known as a data file, can contain only the tables with the data and may be usually stored on a local file server or in the cloud. This setup can allow authorized users to access the necessary data efficiently. The front-end file, or interface file, can provide users with an easy-to-use interface comprising forms, reports, queries, macros, and programming modules. This front-end file, stored on each individual user's desktop, can includes links to the data tables in the back-end file.

Implementing system 100 as the split-database system 150 offers several key advantages including enhanced data sharing, improved network efficiency, and increased system resilience. For example, by separating the interface from the data, the back-end file can be stored on a file server, enabling all authorized users to share and access the data seamlessly. In a non-split database, the network must transfer data, user interface forms, macro code, programming code, query code, and report definitions to each user, leading to slower performance. With a split database, the queries, forms, reports, macros, programming code, and so on, which reside on the user's workstation, can reduce the network load to only transferring data. Furthermore, in the event of a computer crash, a non-split database risks corrupting the database for all users. Conversely, the split-database system 150 can confine the impact of a crash to the individual user's workstation, allowing others to continue working without disruption. Thus, implementing system 100 as or with the split-database system 150 not only ensures efficient data retrieval and reduced latency during high-demand periods but also enhances overall system performance and reliability.

In the above description, specific details of various embodiments are provided. However, some embodiments may be practiced with less than all of these specific details. In other instances, certain methods, procedures, components, structures, and/or functions are described in no more detail than to enable the various embodiments, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

FIG. 6 illustrates an example of a suitable operating environment 800 for implementing various aspects of this disclosure and which can also include a computer 812. The computer 812 can also include a processing unit 814, a system memory 816, and a system bus 834. The system bus 834 couples system components including, but not limited to, the system memory 816 to the processing unit 814. The processing unit 814 can be any of various available processors. Dual microprocessors and other multiprocessor architectures also can be employed as the processing unit 814.

The system bus 834 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1094), and Small Computer Systems Interface (SCSI). The system memory 816 can also include volatile memory 820 and nonvolatile memory 822. The basic input/output system (BIOS), containing the basic routines to transfer information between elements within the computer 812, such as during start-up, is stored in nonvolatile memory 822.

By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/non-volatile computer storage media. FIG. 6 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 834, a removable or non-removable interface is typically used, such as interface 826.

FIG. 6 also depicts software that can act as an intermediary between users and the basic computer resources described in the suitable operating environment 800. Such software can also include, for example, an operating system 828. Operating system 828, which can be stored on disk storage 824, acts to control and allocate resources of the computer 812. System applications 830 can take advantage of the management of resources by operating system 828 through program modules 832 and program data 834, e.g., stored either in system memory 816 or on disk storage 824. It is to be appreciated that this disclosure can be implemented with various operating systems or combinations of operating systems.

A user can enter commands or information into the computer 812 through input device(s) 836. Input device(s) 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 814 through the system bus 834 via interface port(s) 838. Interface port(s) 838 can include, for example, a serial port, a parallel port, a game port, and a universal serial bus (USB). Output device(s) 840 may use some of the same type of ports as input device(s) 836.

Thus, for example, a USB port can be used to provide input to computer 812, and to output information from computer 812 to an output device 840. Output adapter 842 is provided herein to illustrate that there may be some output devices 840 like monitors, speakers, and printers, among other output devices 840, which require special adapters. The output adapters 842 include, by way of illustration and not limitation, video and sound cards that provide a means of connection between the output device 840 and the system bus 834. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor-based appliance, a peer device or other common network node and the like, and typically can also include many or all the elements described relative to computer 812. For purposes of brevity, only a memory storage device 846 is illustrated with remote computer(s) 844. Remote computer(s) 844 can be logically connected to computer 812 through a network interface 848 and then can be physically connected via communication connection 850.

Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers o the hardware/software employed to connect the network interface 848 to, for example, the system bus 834. While communication connection 850 is shown for illustrative clarity inside computer 812, it can also be external to the computer 812. The hardware/software for connection to the network interface 848 can also include, for exemplary purposes only, internal and external technologies such as, modems including regular telephone grade modems, cable modems and DSL modems, ISDN adapters, and Ethernet cards.

Embodiments may be implemented in or as a system, a method, an apparatus and/or a computer program product at any possible technical detail level of integration. The computer program product can include a computer readable storage medium (or media) having computer readable program instructions thereon for causing a processor to carry out aspects of the embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in one or more computing/processing device receives computer readable program instructions from the network and forwards the computer readable program instructions for storage in a computer readable storage medium within the respective computing/processing device.

Computer readable program instructions for carrying out operations of various aspects of the embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages.

The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, to perform aspects of the embodiments.

Aspects of the embodiments are described herein with reference to flowchart illustrations and/or block diagrams of methods, apparatus (systems), and computer program products according to embodiments of the invention. It can be understood that one or more blocks of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions can also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the embodiments. In this regard, one or more blocks in the flowchart or block diagrams can represent a module, segment, or portion of instructions, which comprises one or more executable instructions for implementing the specified logical function(s).

In some alternative implementations of the embodiments, the functions noted in the blocks can occur out of the order noted in the figures. For example, two blocks shown in succession can, in fact, be executed substantially concurrently, or the blocks can sometimes be executed in the reverse order, depending upon the functionality involved. It can also be noted that one or more block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art can recognize that this disclosure also can or can be implemented in combination with other program modules. Generally, program modules include routines, programs, components, data structures, etc. that perform particular tasks and/or implement abstract data types. Moreover, those skilled in the art can appreciate that the inventive computer-implemented methods can be practiced with other computer system configurations, including single-processor or multiprocessor computer systems, mini-computing devices, mainframe computers, as well as computers, hand-held computing devices (e.g., PDA, cellular phone, etc.), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” “module,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer.

By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, the term “processor” can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein.

Further, processors can exploit nano-scale architectures such as, but not limited to, molecular and quantum-dot based transistors, switches and gates, to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

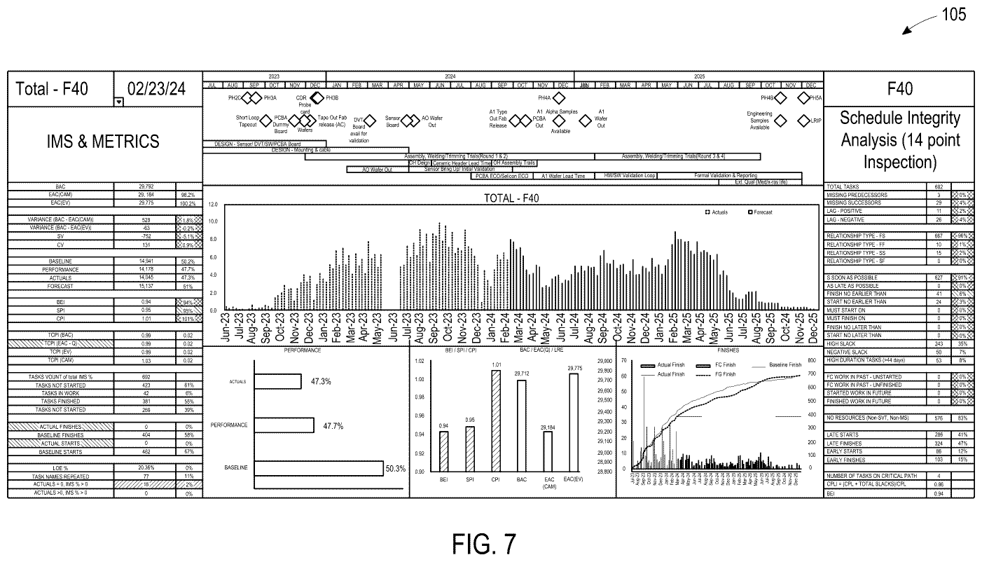

FIG. 7 illustrates a screenshot of an example baseline development interface 105, which may be implemented through the baseline development component 104, in accordance with an embodiment. The baseline development phase through the use of an interface such as interface 105, can primarily use software packages such as, for example, Excel and Project, but in some instances, Access may also be employed. The data cycles back and forth until a realistic, attainable, and viable baseline is developed with the staffing required to execute the plan. This baseline development tool is critical in accomplishing the above. Communication is made easy and efficient with built-in metrics for situational awareness and real-time analysis.

Note that the term “Excel” as utilized herein relates to a spreadsheet editor developed by Microsoft for Windows, macOS, Android, IOS and iPadOS. It features calculations or computation capabilities, graphing tools, pivot tables, and a macro-programming language—Visual Basic for Applications (VBA). “Excel” can refer to “Microsoft Excel”. In addition, the aforementioned “Project” relates to a project management software product, also developed by Microsoft, which is designed to assist a project manager in, for example, developing schedules, assigning resources to tasks, tracking progress, managing a budget, analyzing workloads and so on. The term “Access” as utilized herein relates to a database management system (DBMS) from Microsoft that combines a relational Access Database Engine (ACE) with a graphical user interface. The use of the aforementioned Excel, Project, and Access as discussed herein are not limiting features of the embodiments. Reference herein to these packages are for illustrative and exemplary purposes only.

The baseline development interface 105 can be implemented with detachable windows along with a drop down section (at the right hand side of interface), which a user may access to select a program. A variety of other sections are shown in FIG. 7 including a section located at the left hand side of the interface wherein various metrics are displayed or indicated.

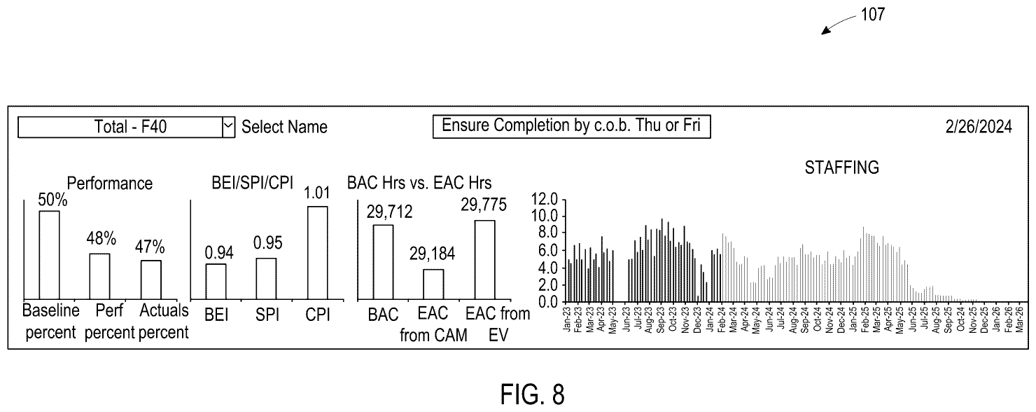

FIG. 8 illustrates a screenshot of an example program execution interface 107, which may be implemented as part of a program execution component 106, in accordance with an embodiment. The program execution phase can use, for example, Access, Excel, and Project. CAMs (Control Access Managers) can update all programs that they're working on, directly from their desktop, using one file. The data can be then exported from Access to Excel where it can be processed before being imported to Project. The updates can be made in Project, then exported to excel where it's processed before being imported into Access so the team has the results and overall impact of their updates. Communication is made easy and efficient with built-in metrics for situational awareness and real-time analysis

Note that the term CAM or “Control Access Manager” as utilized herein relates to a system and/or software that can regulate and manages access to resources, data, or services within an organization or network. A primary function of a CAM function is to enforce security policies by controlling who can access specific resources, under what conditions, and what actions they can perform. CAM systems typically involve verifying the identity of users or devices attempting to access resources, determining the level of access or permissions granted to authenticated users based on predefined policies, and keeping track of access events, actions taken by users, and providing logs or reports for security reviews. CAM systems can be used to protect sensitive data, ensure compliance with regulations, and prevent unauthorized access to critical resources. They can be integrated with other security measures such as firewalls, encryption, and multi-factor authentication.

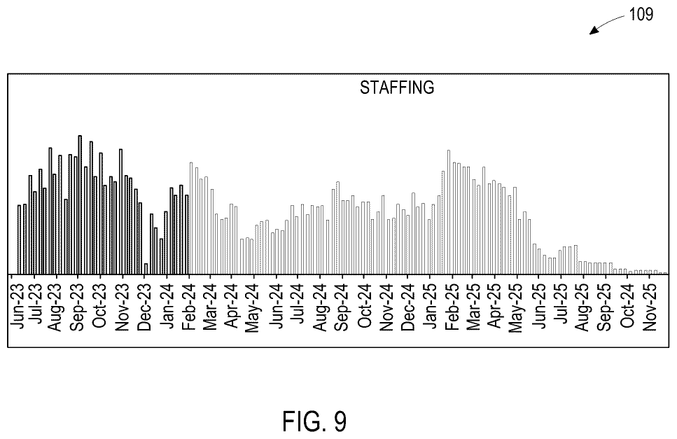

FIG. 9 illustrates a screenshot of an example portfolio workforce planning interface 109, which may be implemented as part of a portfolio workforce planning component 108, in accordance with an embodiment. The workforce planning component 108 can use, for example, a software tool such as Access, and can contain the entire workforce by name and the staffing demand from all proposals (future demand) and all programs that are underway (current demand). This efficiently depicts the complete portfolio picture by capturing the current state and forecasted future state to make informed strategic decisions. This can provide early warning at the Portfolio level for staffing requirements.

Staffing demand can be pinpointed across the entire portfolio to manage priorities and prepare for future requirements. Another massive benefit is that the workforce planning data can be leveraged for an efficient and accurate EAC process for all programs in the portfolio. Programs can validate their staffing requirements, and functional managers can use a Program Staffing Demand feature to allocate their resources. The Workforce Planning tool (i.e., portfolio workforce planning component 108) can filter data at all levels including by, for example: Program, Function, Organization, Department, Skill Set, Work Type, and Employee It can also determine the timing of when specific skill sets will be needed. Other features, which may be implemented can include, for example, (1) Drop Downs to Select Program THEN Function, Department, Skill Set (2) Drop Downs to Select Function, Department, Skill Set THEN Program (3) A timeline with Milestones across the top and (4) Detachable Windows (5) Gantt chart (6) Programmatic EV Summary.

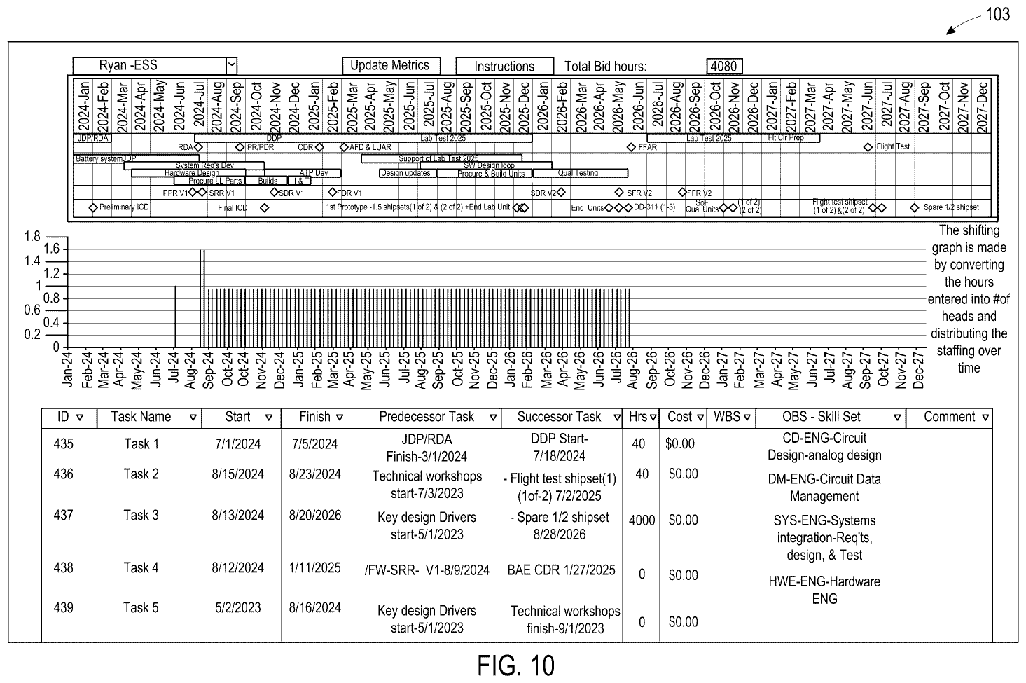

FIG. 10 illustrates a screenshot of an example proposal development interface 103, which may be implemented as part of an example proposal development component 102, in accordance with an embodiment. The proposal development process can use software packages such as, for example, Access, Excel, and Project and can cycle through at least twice before moving on to the baseline development tool/interface 105. A specific sequence of events can streamline the process, and the proposal tool can assist with efficient data gathering, accurate estimating in both hours and dollars, and real-time reviewing. Communication is made easy and efficient with built-in metrics for situational awareness and realistic data entry.

The Proposal Development process can be implemented as a comprehensive workflow that involves the use of Access, Excel, and Project, cycling through each at least twice before advancing to the Baseline Development Tool. The process can be designed to be streamlined, with a specific sequence of events ensuring efficiency. The proposal tool facilitates efficient data gathering, accurate estimation of hours and dollars, and real-time reviewing. Built-in metrics enhance communication by providing situational awareness and ensuring realistic data entry.

In Access, several tables are loaded into the backend, including but not limited to WBS (Work Breakdown Structure), OBS (Organizational Breakdown Structure), Department, Skill Set, POP (Period of Performance), MS (Milestones) with target dates, CAM (Control Account Manager) List, and Risk. These tables create dropdown menus that ensure accuracy and standardization, ultimately saving time and money. CAMs enter high-level tasks and confirm staffing demands to maintain realism. The visibility of staffing demands ensures that resources are appropriately allocated, leading to realistic proposals that account for risk factors. The initial pass does not have to be perfect, allowing activities to be placed between major milestones or linked internally to the tasks the CAM enters. CAMs also enter the cost of services and materials. Once this is completed, the data is exported from Access to Excel. Note that in Excel, the data from Access can be imported, prepared, and then exported to Project.

If necessary, one-on-one meetings with CAMs can supplement their internal linking. Steps involving Access, Excel, and Project are repeated to refine the CAM internal linking within Project. Once the internal linking data is successfully integrated into Project, schedule development continues and is analyzed in the Baseline Development Tool. This includes both internal and external linking across CAMs, which enhances communication and coordination. Durations are adjusted to ensure that current staffing levels support the schedule, or to highlight the need for additional staffing. This step is crucial for Proposal Schedules and absolutely essential for Baseline Schedules.

What has been described above include mere examples of systems, computer program products, and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible.

Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration but are not intended to be exhaustive or limited to the embodiments disclosed.

Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. A method for integrating a plurality of disjunct processes into a cohesively systematic workflow, the method comprising:
receiving, through a system operatively linked to a back end processor, via a front end user interface, an input to a proposal development application for development of a proposal, the input comprising a proposal development customizable with changes to parameters on a case-by-case basis indicative of a specific sequence of events, wherein the proposal development application collects data for determining staffing demands and estimating costs for use in generating the proposal, the system including a database comprising a split-database comprising a shared system database and a customer-specific database, each story respective computer-executable instructions and data structures;
subjecting, by the system, data imported from the proposal development application to a baseline development application comprising an iterative baseline-development process that automatically performs multi-variable computational analysis of schedule, cost, and staffing data retrieved from the split-database, wherein the baseline-development application iteratively processes the data in order to confirm critical/driving paths, establish target dates, and provide a highest probability of various cost and schedule performance metrics remaining within tolerances after setting a baseline and throughout a lifetime of a program related to the proposal;
importing, by the system, data processed by the baseline development application, and updating with a program execution application, all tasks in a schedule comprising the program, displaying critical/driving paths, and monitoring a plurality of performance metrics; and
integrating through the system and with a portfolio workforce planning application, staffing data from the data processed by the proposal development application, the baseline development application, and the program execution component.

2. The method of claim 1 wherein the split-database comprises data portioning including horizontal partitioning and vertical portioning, wherein in the horizontal partitioning, database tables are split into rows with each segment thereof containing a subset of rows and each partition thereof holding a range of data, and wherein in the vertical partitioning the database tables are split into columns, with each segment containing a subject of the columns, resulting in a technological improvement when columns are frequently accessed together.

3. The method of claim 1 further comprising pinpointing a site-wide staffing demand in order to ensure that a supported company has personnel, in response to integrating the staffing data, the baseline development application and the program execution component.

4. The method of claim 1 further comprising generating data usable by a team for insight into how the team operates and delegates resources more efficiently and cost-effectively, in response to integrating the staffing data, the baseline application application and the program execution application.

5. The method of claim 1 further comprising ensuring multiple commonly disjunct factors, in response to integrating the staffing data, the baseline development application and the program execution application.

6. The method of claim 1 wherein the multiple common factors including at least one of: a cost, the schedule, a workforce, and performance tracking.

7. The method of claim 1, further comprising dynamically adjusting the parameters of the proposal development application based on real-time feedback received from the baseline development application and the program execution component.

8. The method of claim 1, wherein the proposal development application further includes a machine learning algorithm configured to predict staffing demands and cost estimates based on historical data and trends.

9. The method of claim 1, further comprising generating visual analytics dashboards that display critical paths, performance metrics, and staffing data for easy interpretation by end users.

10. The method of claim 2, wherein the split-database employs a caching mechanism to improve data retrieval speed and reduce latency.

11. The method of claim 1, wherein the program execution application alerts relevant stakeholders of deviations from the established baseline or critical paths.

12. The method of claim 3, further comprising automatically recommending staffing adjustments based on predictive analytics derived from historical project data and current program execution metrics.

13. An apparatus for integrating a plurality of disjunct processes into a cohesively systematic workflow, the apparatus comprising:
at least one processor and a memory, the memory storing instructions to cause the at least one processor to perform:
receiving, through a system operatively linked to a back end processor, via a front end user interface, an input to a proposal development application for development of a proposal, the input comprising a proposal development customizable with changes to parameters on a case-by-case basis indicative of a specific sequence of events, wherein the proposal development application collects data for determining staffing demands and estimating costs for use in generating the proposal, the system including a database comprising a split-database comprising a shared system database and a customer-specific database, each story respective computer-executable instructions and data structures;
subjecting, by the system, data imported from the proposal development component to a baseline development application comprising an iterative baseline-development process that automatically performs multi-variable computational analysis of schedule, cost, and staffing data retrieved from the split-database, wherein the baseline development application iteratively processes the data in order to confirm realistic critical/driving paths, establish attainable target dates, and provide a highest probability of various cost and schedule performance metrics remaining within tolerances after setting a baseline and throughout a lifetime of a program related to the proposal;
importing, by the system, data processed by the baseline development application, and updating with a program execution application, all tasks in a schedule comprising the program, displaying critical/driving paths, and monitoring a plurality of performance metrics; and
integrating, through the system, staffing data from the data processed by the proposal development application, the baseline development application, and the program execution application.

14. The apparatus of claim 13 wherein the split-database comprises data portioning including horizontal partitioning and vertical portioning, wherein in the horizontal partitioning, database tables are split into rows with each segment thereof containing a subset of rows and each partition thereof holding a range of data, and wherein in the vertical partitioning the database tables are split into columns, with each segment containing a subject of the columns, resulting in a technological improvement when columns are frequently accessed together.

15. The apparatus of claim 13 wherein the instructions are further configured to cause the at least one processor to perform: dynamically adjusting the parameters of the proposal development component based on real-time feedback received from the baseline development component and the program execution component.

16. The apparatus of claim 14, wherein the split-database employs a caching mechanism to improve data retrieval speed and reduce latency.

17. (canceled)

18. (canceled)

19. (canceled)

20. (canceled)

21. A computer-implemented method for generating integrated program-management data, the method executed by a back-end processor operatively connected to a front-end user interface and to a split-database architecture comprising a shared system database and a customer-specific database, the method comprising:
receiving, through the front-end user interface, proposal-development data for processing by a proposal-development application comprising computer-executable instructions stored in the shared system database, the proposal-development application configured to collect staffing-requirement information and cost-estimating information for a project;
executing, by the back-end processor, an iterative baseline-development process comprising programmed routines stored in the shared system database, the iterative baseline-development process using the staffing-requirement information and the cost-estimating information to analyze schedule data, verify critical or driving paths, establish target dates, and compute cost-performance and schedule-performance metrics to determine whether the metrics remain within predetermined tolerances;
storing, in the customer-specific database, results generated by the iterative baseline-development process;
executing, by the back-end processor, a program-execution application comprising computer-executable instructions stored in the customer-specific database, the program-execution application being configured to update tasks within an Integrated Master Schedule stored in the customer-specific database based on the results generated by the iterative baseline-development process, and to provide, through the front-end user interface, displays of the updated critical or driving paths and performance metrics; and
executing, by the back-end processor, workforce-planning routines stored in the shared system database, the workforce-planning routines retrieving data from both the shared system database and the customer-specific database to automatically integrate the staffing-requirement information, the results generated by the iterative baseline-development process, and the updated tasks within the Integrated Master Schedule, thereby generating portfolio-level workforce-planning data.

22. The method of claim 21, wherein executing the iterative baseline-development process comprises identifying a critical path or a driving path for the project and verifying, for each iteration, whether the cost-performance metrics and the schedule-performance metrics remain within the predetermined tolerances.

23. The method of claim 21, wherein providing the displays through the front-end user interface comprises presenting the critical path or the driving path and the cost-performance metrics and the schedule-performance metrics updated by the program-execution application.

24. The method of claim 21, wherein generating the portfolio-level workforce-planning data comprises integrating the staffing-requirement information for a plurality of projects stored in the split-database architecture.
